(19) United States
(12) Patent Application Publication
(10) Pub. No.: US 2005/0215732 A1
(43) Pub. Date: Sep. 29, 2005

(54) Composition for film formation, coating solution containing the same and electronic device having insulating film obtained by using the coating solution

(75) Inventors: Katsuyuki Watanabe, Shizuoka (JP); Yutaka Adegawa, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/084,251

(22) Filed: Mar. 21, 2005

(30) Foreign Application Priority Data
Mar. 23, 2004 (JP) P2004-084661
Mar. 18, 2005 (JP) P2005-078687

(51) Int. Cl. C08G 85/00

(52) U.S. Cl. 526/62

(57) ABSTRACT

A composition for a film formation, the composition obtained by a Diels-Alder reaction of at least one compound (A) having two or more 2-pyrone groups with at least one compound (B) having two or more dienophile functional groups, wherein the composition satisfies at least one of a condition (a) and a condition (b): condition (a): said at least one compound (A) includes a compound having three or more 2-pyrone groups; and condition (b): said at least one compound (B) includes a compound having three or more dienophile functional groups.

### BACKGROUND OF THE INVENTION

1. Field of the Invention

The present invention relates to a material for forming an insulating film, more specifically, a material for forming an insulating film, which can form, as an interlayer insulating film material in electronic devices and the like, a coating film having an appropriate and uniform thickness and good dielectric constant, heat resistance and mechanical strength. The present invention also relates to an electronic device having an insulating film obtained by using the coating solution.

2. Description of the Related Art

In the field of electronic materials, with recent progress toward higher integration, greater multifunctions and higher performances, the circuit resistance or interwiring capacitance is increased and this is incurring increase of the power consumption or delay time. In particular, the increase of the delay time constitutes a major cause of the reduction in the signal speed of a device or the generation of crosstalk and in order to alleviate the delay time and achieve high-speed operation of a device, it is demanded to decrease the parasitic resistance or parasitic capacitance. One specific measure taken for decreasing the parasitic capacitance is to coat the periphery of wiring with a low-dielectric interlayer insulating film. The interlayer insulating film is also required to have not only excellent heat resistance capable of enduring the thin film formation step at the production of a mounted substrate or the post-step such as chip connection and pin insertion but also chemicals resistance capable of enduring the wet process. Furthermore, low-resistance Cu wiring is being introduced in place of Al wiring and with this introduction, planarization by CMP (chemical-mechanical polishing) is generally performed and a mechanical strength capable of enduring this process is demanded.

Polyimides are widely known as a highly heat-resistant organic material but since an imide group having high polarity is contained therein, those satisfied in view of low dielectricity, low water absorptivity, durability and hydrolysis resistance are not obtained.

As for the insulating film material, a polymer or partial polymer of heat-curable benzocyclobutene (BCB), which is a hydrocarbon-based polymer, is disclosed (see, U.S. Pat. No. 4,812,588). J. K. Stille et al. are disclosing polyphenylenes synthesized from a bispyrone compound and a bisacetylene compound (see, Macromolecules, Vol. 5, pp. 541-546 (1972) and Macromolecules, Vol. 11, pp. 343-346 (1978)). In these publications, it is reported that a heat-resistant polymer is obtained. However, the material proposed by J. K. Stille et al. is reported to have low solubility in an organic solvent and can be hardly dissolved in a coating solution. Furthermore, this material has a relatively high molecular weight by using up the pyrone moiety through polymerization and therefore, when coated by spin coating on a patterned surface, can hardly fill the gaps while keeping good planarity. In addition, this polymer is not necessarily satisfied in view of mechanical strength or heat resistance, because the polymer is a reaction product of bifunctional monomers with each other and is not crosslinked.

### SUMMARY OF THE INVENTION

An object of the present invention is to overcome the above-described problems and provide a composition for film formation, more specifically, a composition for film formation, which can form, as an interlayer insulating film in electronic devices and the like, a coating film having good planarity and uniform thickness, can fill gaps without leaving a void, and can form a coating film excellent in the heat resistance, dielectric property and mechanical strength.

It has been found that the object of the present invention can be attained by the following constitutions (1) to (14).

(1) A composition for a film formation, the composition obtained by a Diels-Alder reaction of at least one compound (A) having two or more 2-pyrone groups with at least one compound (B) having two or more dienophile functional groups,

wherein the composition satisfies at least one of a condition (a) and a condition (b):

condition (a): said at least one compound (A) includes a compound having three or more 2-pyrone groups; and

condition (b): said at least one compound (B) includes a compound having three or more dienophile functional groups.

(2) The composition as described in (1) above, wherein said at least one compound (A) is represented by formula (I):
[P-(L¹)ₘ [symbol] ₙQ (I)
wherein n represents an integer of 2 or more; each of P's represents a 2-pyrone group;

each of L¹'s represents a divalent linking group;

Q represents an aliphatic hydrocarbon group, an aromatic hydrocarbon group or a heterocyclic group; and

each of m's represents 0 or 1, and each of P's, L¹'s and m's are the same or different.

(3) The composition as described in (1) or (2) above,

wherein said at least one compound (B) is represented by formula (II):

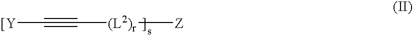

wherein s represents an integer of 2 or more;

each of Y's represents a hydrogen atom, an alkyl group or an aryl group;

each of L²'s represents a divalent linking group;

Z represents an aliphatic hydrocarbon group, an aromatic hydrocarbon group or a heterocyclic group; and

each of r's represents 0 or 1, and each of Y's, L²'s and r's are the same or different.

(4) The composition as described in any of (1) to (3) above, comprising at least one of an oligomer, an uncured polymer and a cured polymer, each obtained by the Diels-Alder reaction.

(5) The composition as described in any of (1) to (4) above, which is capable of forming a film having a Young's modulus of 5 GPa or more.

(6) The composition as described in any of (1) to (4) above, which is capable of forming a film having a relative dielectric constant of 2.60 or less.

(7) A film obtained by a process, the process comprising using a composition for a film formation as described in any of (1) to (6) above.

(8) The film as described in (7) above, the using comprising:

applying the composition to a substrate to produce an applied composition; and

heating the applied composition at a temperature of from 100° C. to 475° C., so as to form the film.

(9) The film as described in (8) above,

wherein the heating the applied composition is performed for 1 minute to 10 hours.

(10) The film as described in any of (7) to (9) above, which has an uniformity of a film thickness of less than 3%.

(11) The film as described in any of (7) to (10) above, which has a Young's modulus of 5 GPa or more.

(12) The film as described in (7) to (10) above, which has a relative dielectric constant of 2.60 or less.

(13) A coating solution for a film formation, comprising a composition for a film formation as described in any of (1) to (6) above.

(14) An electronic device having an insulating film obtained by using a coating solution for a film formation as described in (13) above.

### DETAILED DESCRIPTION OF THE INVENTION

The present invention is described in detail below. Compound (A) Having Two or More 2-Pyrone Groups

The 2-pyrone group as used in the present invention indicates a group produced by removing one hydrogen atom from the compound represented by the following formula (III):

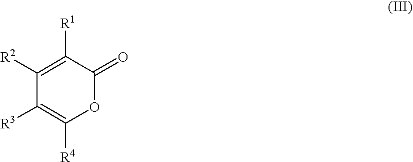

wherein R¹ to R⁴ each independently represents a hydrogen atom or a substituent.

In formula (III), R¹ to R⁴ each independently represents a hydrogen atom or a substituent. The substituent as used herein may be any one as long as it does not adversely affect various performances as the insulating film. In particular, preferred examples thereof include a halogen atom (e.g., fluorine, chlorine, bromine, iodine), a linear, branched, cyclic or polyhedral alkyl group having from 1 to 20 carbon atoms (e.g., methyl, tert-butyl, cyclohexyl, adamantyl), an alkenyl group having from 2 to 20 carbon atoms (e.g., vinyl, propenyl), an alkynyl group having from 2 to 20 carbon atoms (e.g., ethynyl, phenylethynyl), an aryl group having from 6 to 30 carbon atoms (e.g., phenyl, 1-naphthyl, 2-naphthyl), an acyl group having from 2 to 20 carbon atoms (e.g., benzoyl), an aryloxy group having from 6 to 30 carbon atoms (e.g., phenoxy), an arylsulfonyl group having from 6 to 30 carbon atoms (e.g., phenylsulfonyl), a nitro group, a cyano group and a silyl group (e.g., triethoxysilyl, methyldiethoxy-silyl, phenyldimethoxysilyl).

Among these substituents, preferred are a halogen atom, a branched, cyclic or polyhedral alkyl group having from 4 to 20 carbon atoms, an alkenyl group having from 2 to 20 carbon atoms, an alkynyl group having from 2 to 20 carbon atoms, an aryl group having from 6 to 30 carbon atoms, an acyl group having from 2 to 20 carbon atoms, an aryloxy group having from 6 to 30 carbon atoms, an arylsulfonyl group having from 6 to 30 carbon atoms and a silyl group.

A still more preferred substituent is an aryl group having from 6 to 30 carbon atoms.

The substituents represented by R¹ to R⁴ each may be further substituted by another substituent.

The 2-pyrone group for use in the present invention is most preferably a residue after removing the hydrogen atom at the 5-position of an unsubstituted 2-pyrone.

The compound (A) having two or more 2-pyrone groups is preferably represented by the following formula (I):
[P-(L¹)ₘ [symbol] ₙQ (I)

wherein each of P's represents a 2-pyrone group, each of L¹'s represents a divalent linking group, Q represents an aliphatic hydrocarbon group, an aromatic hydrocarbon group or a heterocyclic group, each of m's represents 0 or 1, and n represents an integer of 2 or more, and plural P's, L¹'s and m's each may be the same or different.

In formula (I), each of L¹'s represents a divalent linking group. The divalent linking group as used herein is preferably —C(R¹¹) (R¹²)—, —C(R¹³)═C(R¹⁴)—, —C≡C—, an arylene group, —CO—, —O—, —SO₂—or a group comprising a combination thereof. Here, R¹¹, R¹², R¹³ and R¹⁴ each represents a hydrogen atom, an alkyl group or an aryl group, and each of the pairs R¹¹ and R¹², and R¹³ and R¹⁴ may combine with each other to form a ring. The linking group is more preferably —C(R¹¹) (R¹²)—, —C≡C—, an arylene group, —CO—, —O— or a group comprising a combination thereof, still more preferably —C(R¹¹) (R¹²)—, an arylene group, —O— or a group comprising a combination thereof. In particular, R¹¹ and R¹² preferably form a 5- or 6-membered carbon ring.

These linking groups each may have a substituent and preferred examples of the substituent are the same as those described for the substituents R¹ to R⁴ in formula (I).

In formula (I), n [P-(L¹)ₘ]'s substituted to Q may be the same or different.

Q represents an n-valent aliphatic hydrocarbon group, an n-valent aromatic hydrocarbon group or an n-valent heterocyclic group, preferably an n-valent aliphatic hydrocarbon group or an n-valent aromatic hydrocarbon group, more preferably an n-valent aromatic hydrocarbon group.

Q may have a substituent and preferred examples of the substituent are the same as those described for the substituent which the substituents R¹ to R⁴ in formula (I) each may have.

n is preferably an integer of 2 to 5, more preferably an integer of 2 to 4, still more preferably 2 or 3.

The compound (A) having two or more 2-pyrone groups preferably has a molecular weight of 190 to 10,000, more preferably from 250 to 1,000, still more preferably from 250 to 500. Specific examples of the compound (A) having two or more 2-pyrone groups are set forth below, but the present invention is not limited thereto.

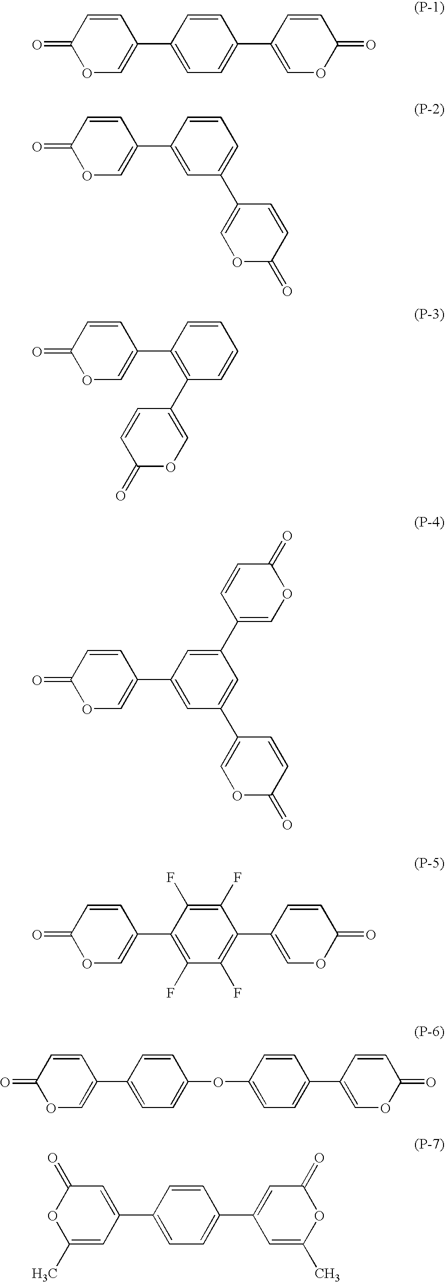

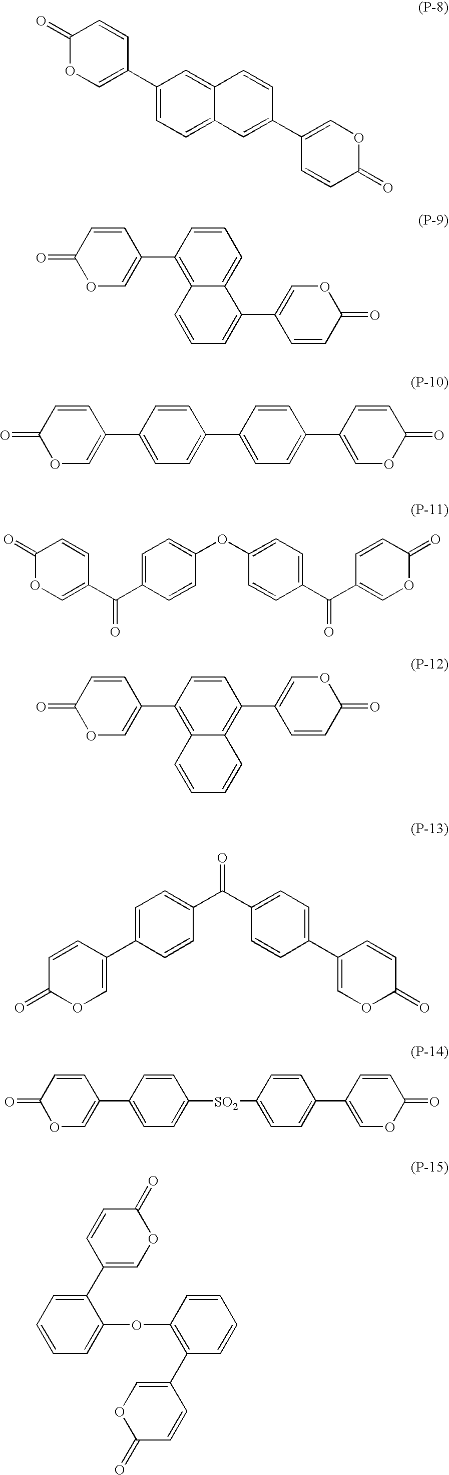

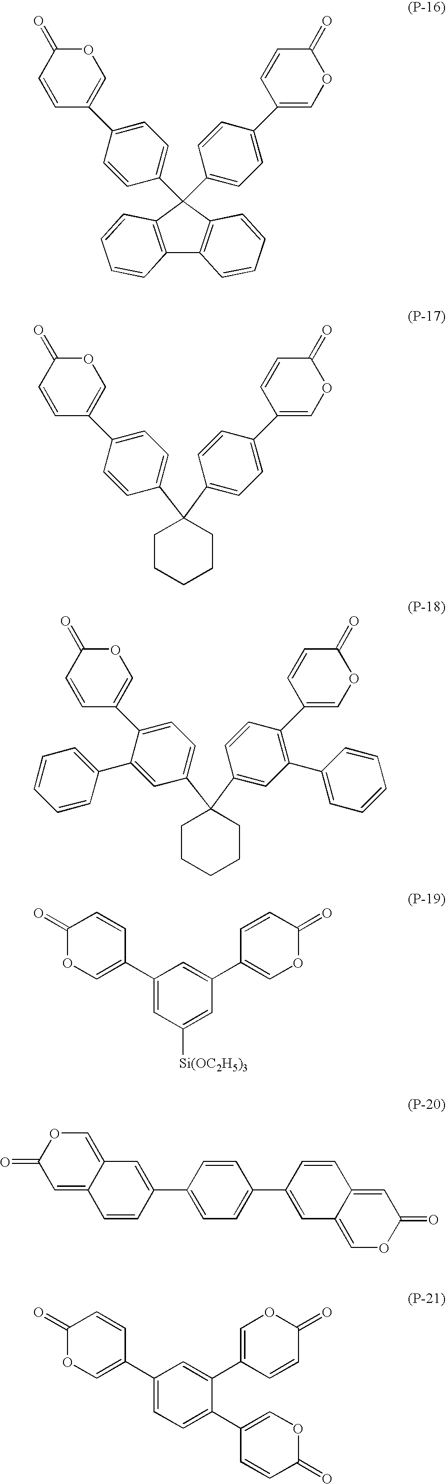

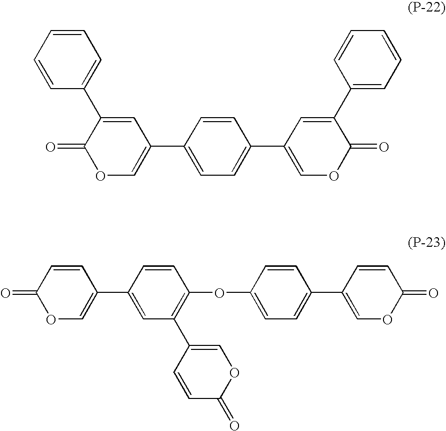

The compound (A) having two or more 2-pyrone groups can be synthesized by or according to a known method. For example, a specific synthesis method of Compound (P-1) is described in Macromolecules, 5, pp. 541-546 (1972) and Journal of Organic Chemistry, 61, pp. 6693-6699 (1996). Also, a specific synthesis method of Compound (P-2) is described in Macromolecules, 11, pp. 343-346 (1978) Compound (B) Having Two or More Dienophile Functional Groups

A dienophile functional group is an unsaturated bond part which additionally react with a diene part in Diels-Alder reaction to form a cyclic compound. The dienophile functional group in the compound (B) having two or more dienophile functional groups is preferably an acetylene group, and the compound is preferably represented by the following formula (II):

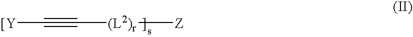

wherein each of Y's represents a hydrogen atom, an alkyl group or an aryl group, each of L²'s represents a divalent linking group, Z represents an aliphatic hydrocarbon group, an aromatic hydrocarbon group or a heterocyclic group, each of r's represents 0 or 1, s represents an integer of 2 or more, and plural Y's, L²'s and r's each may be the same or different.

In formula (II), each of Y's is preferably a hydrogen atom or an aryl group (e.g., phenyl), more preferably a hydrogen atom.

In formula (II), each of L²'s represents a divalent linking group, preferably —C(R¹¹) (R¹²)—, —C(R¹³)═C(R¹⁴)—, —C≡C—, an arylene group or a group comprising a combination thereof. Here, R¹¹, R¹², R¹³ and R¹⁴ each represents a hydrogen atom, an alkyl group or an aryl group, and each of the pairs R¹¹ and R¹², and R¹³ and R¹⁴ may combine with each other to form a ring. The linking group is more preferably an arylene group.

Z represents an s-valent aliphatic hydrocarbon group, an s-valent aromatic hydrocarbon group or an s-valent heterocyclic group, preferably an s-valent aliphatic hydrocarbon group or an s-valent aromatic hydrocarbon group, more preferably an s-valent aromatic hydrocarbon group.

Z may have a substituent and preferred examples of the substituent are the same as those described for the substituent which the substituents R¹ to R⁴ in formula (III) each may have.

s is preferably an integer of 2 to 5, more preferably an integer of 2 to 4, still more preferably 2 or 3.

In formula (II), s [Y—≡-(L²)ᵣ]'S substituted to Z may be the same or different.

Specific examples of the compound (B) having two or more dienophile functional groups are set forth below, but the present invention is not limited thereto.

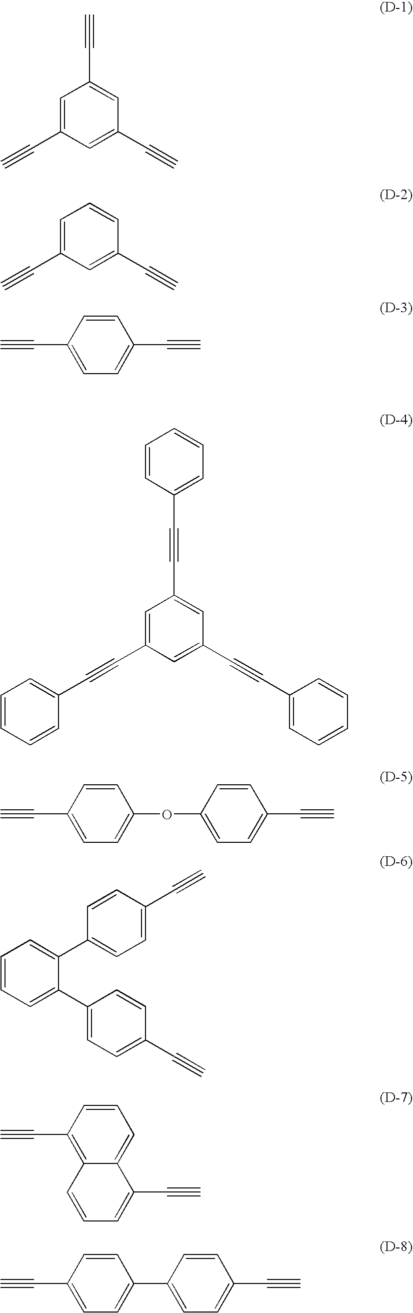

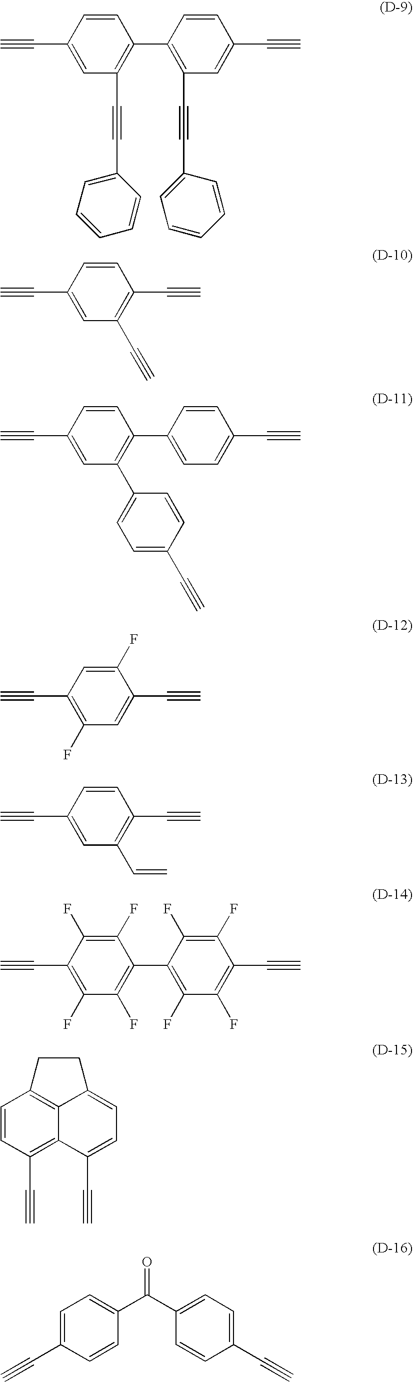

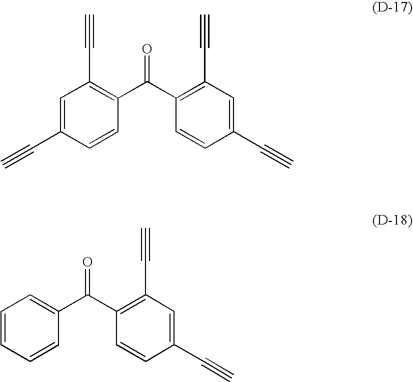

The compound (B) having two or more dienophile functional groups can be synthesized by a related-art method. For example, an aromatic compound is halogenated and then reacted with an appropriate acetylene compound in the presence of an aryl ethynylation catalyst such as palladium to displace the halogen, whereby the compound can be synthesized. For example, the synthesis method of Compound (D-1) is described in Journal of the Chemical Society. Perkin Transaction., 2, page 1256 (1988). Also, for example, Compounds (D-2) and (D-3) are commercially available.

Purification at the Synthesis

The polyfunctional compound is preferably purified at the synthesis. Particularly, when the film is used as an insulating film of semiconductors, metals and ionic substances must be removed. In one preferred purification method, for example, a polyfunctional group containing an aromatic acetylene group is dissolved in an aliphatic hydrocarbon solvent and the solution in the organic solvent is washed with water and then filtered through pure silica gel. This treatment is effective for removing the residual ethynylation catalyst. Recrystallization following this treatment is also effective for the removal of undesired impurities.

Polymerization Reaction

The oligomerization, polymerization and curing reactions can be achieved by a Diels-Alder reaction of the diene moiety of the 2-pyrone group with the dienophile functional group, but the reaction is not limited thereto. The dienophile functional group is preferably an acetylene group, because the Diels-Alder reaction represented by the following scheme results in release of carbon dioxide and formation of an aromatic ring. The formation of an aromatic ring is greatly advantageous in view of thermal stability (chemical and physical heat resistance) of the product and prevention of the reverse Diels-Alder reaction.

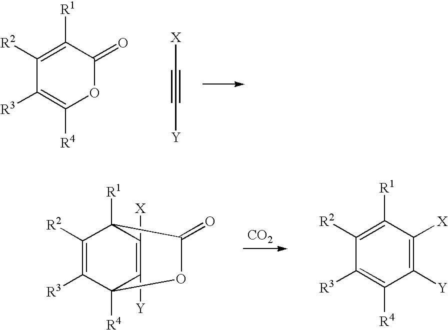

The solvent which can be used for the Diels-Alder reaction in the preparation of the composition for film formation of the present invention is an inactive organic solvent which can dissolve the monomers of the compound (A) having two or more 2-pyrone groups and the compound (B) having two or more dienophile functional groups to an appropriate degree and can be heated to an appropriate polymerization temperature under atmospheric pressure, reduced pressure or pressure.

Suitable examples of the solvent include mesitylene, pyridine, triethylamine, N-methylpyrrolidinone (NMP), methyl benzoate, ethyl benzoate, butyl benzoate, cyclo-pentanone, cyclohexanone, cycloheptanone, cyclooctanone, cyclohexylpyrrolidinone, ethers or hydroxy ethers (e.g., dibenzylether, diglyme, triglyme, diethylene glycol ethyl ether, diethylene glycol methyl ether, dipropylene glycol methyl ether, dipropylene glycol dimethyl ether, propylene glycol phenyl ether, propylene glycol methyl ether, tripropylene glycol methyl ether), toluene, mesitylene, xylene, benzene, dipropylene glycol monomethyl ether acetate, dichlorobenzene, trichlorobenzene, propylene carbonate, naphthalene, diphenyl ether, butyrolactone, dimethylacetamide, dimethylformamide, ethyl lactate and a mixture thereof. Preferred solvents are mesitylene, N-methylpyrrolidinone (NMP), γ-butyrolactone, diphenylether, trichlorobenzene and a mixture thereof.

The polymerization reaction conditions vary depending on various factors such as reactant and solvent, but this reaction is usually performed in a non-oxidative atmosphere, for example, in a nitrogen or other inert gas. This reaction may be performed without using a solvent, but for the purpose of ensuring a homogeneous reaction mixture, an inactive organic solvent described above is preferably used.

The monomer concentration at the polymerization reaction is, in terms of the total amount, preferably from 5 to 70 weight %, more preferably from 10 to 50 weight %, still more preferably from 20 to 40 weight %.

The reaction time and temperature vary depending on the solvent used, but the reaction for the formation of an oligomer is usually performed at a temperature of 150 to 250° C. for 60 minutes to 72 hours, and the composition for film formation is obtained as the reaction product.

At this stage, the oligomer may be isolated from the reaction mixture and formed into a coating solution by dissolving in a coating solvent or used as the reaction mixture for the coating of the surface of a coating object.

As for the polymerization of the oligomer after coating and the curing of the polymer, it is preferred to perform the baking and curing at a temperature of usually from 100 to 475° C., preferably from 200 to 450° C., and preferably for 1 minute to 10 hours, more preferably from 1 minute to 1 hour, thereby completing the polymerization reaction and crosslinking reaction and curing the polymer.

By employing such conditions at the reaction, an uncured polymer and a cured polymer can be obtained.

In the present invention, the ratio of the 2-pyrone group to the dienophile functional group varies depending on many factors including monomers and organic liquid used and oligomer and polymer intended to produce, but the molar ratio of 2-pyrone group: dienophile functional group is preferably from 1:0.5 to 1:3, more preferably from 1:1 to 1:2, still more preferably from 1:1 to 1:1.3.

The proportion of the compound having three or more 2-pyrone groups in the total amount of the compound (A) having two or more 2-pyrone groups is usually from 0 to 50 mol %, preferably from 0 to 10 mol %. The compound having three or more 2-pyrone groups is preferably a compound having from three to five 2-pyrone groups, more preferably three or four 2-pyrone groups.

The proportion of the compound having three or more dienophile functional groups in the total amount of the compound (B) having two or more dienophile functional groups is usually from 10 to 100 mol %, preferably from 50 to 100 mol %.

The compound having three or more dienophile functional groups is preferably a compound having from three to five dienophile functional groups, more preferably three or four dienophile functional groups.

Form of Composition for Film Formation

The composition for film formation of the present invention is preferably in the form of an oligomer, an uncured polymer or a cured polymer.

The oligomer as used herein means a reaction product of two or more monomer units of the present invention (a compound synthesized from two or more monomers), which fills gaps, namely, which voidlessly fills irregular grooves in a depth of 1.0 micron and a width of 1.5 micron when cured.

The uncured polymer means a reaction product which unlike oligomer, cannot fill irregular grooves in a depth of 1.0 micron and a width of 1.5 micron when cured, but allows for remaining of unreacted 2-pyrone and dienophile functional groups capable of causing a Diels-Alder reaction.

The cured polymer means a reaction product not containing unreacted 2-pyrone and dienophile functional groups capable of causing a Diels-Alder reaction.

The number of monomer units constituting the composition for film formation of the present invention is preferably from 2 to 1,000, more preferably from 2 to 50, still more preferably from 2 to 20.

In the composition for film formation of the present invention, an unreacted functional group may be contained within the range of not adversely affecting the performances (for example, dielectric constant, heat resistance and mechanical strength) of the insulating film.

Also, in the composition for film formation of the present invention, an unreacted functional group may be contained along with the cured polymer within the range of not adversely affecting the performances of the insulating film.

Preparation of Coating Solution for Film Formation

As for the coating solution for film formation, the reaction solution containing the reaction product (composition for film formation) resulting from the above-described reaction may be used as-is or may be used after adding other solvents or additives, or the coating solution may be prepared by extracting the reaction product (oligomer or polymer) from the reaction solution, dissolving it in another solvent and adding other additives.

For example, the monomers may be reacted in one or more solvent(s) at a high temperature and the obtained oligomer solution may be cooled and formulated by adding thereto one or more other solvent(s) for the purpose of, for example, enhancing the processability. In another method, the monomers may be reacted in one or more solvent(s) at a high temperature to form an oligomer and the oligomer may be isolated by precipitation with an addition of an appropriate solvent or by other solvent-removing means to obtain a substantially solvent-free oligomer. It is also possible to re-dissolve the isolated oligomer in one or more different solvent(s) and use the obtained solution for the processing.

Coating Film

The composition for film formation of the present invention is characterized in that a coating film having good planarity can be formed. The planarity is described in detail, for example, in Proceedings of IEEE, Vol. 80, No. 12, page 1948 (December, 1992).

The composition for film formation (particularly the polymer) of the present invention can be used as one or more insulating or dielectric layer(s) in a single or multilayer electrical interconnect structure for integrated circuits, multichip modules and flat panel displays. The composition for film formation (particularly the polymer) of the present invention can be used in these uses as a sole dielectric material or together with other organic polymers or inorganic dielectric materials such as silicon dioxide, silicon nitride and silicon oxynitride.

Further, the composition for film formation of the present invention is capable of forming a film having a Young's modulus of 5 GPa or more at 25° C. and a relative dielectric constant of 2.60 or less.

For example, in the case of forming an insulating film on a wafer, a coating solution prepared by dissolving the composition for film formation (oligomer or polymer) of the present invention in an organic solvent is spin-coated and after evaporating the solvent, the oligomer or polymer is exposed to a temperature high enough to advance the oligomer or polymer to a higher molecular weight, most preferably to a crosslinked polymer having a high glass transition temperature, whereby the insulating film can be easily produced.

The composition for film formation (particularly polymer) of the present invention is effective especially as a low-dielectric insulating material in an interconnect structure of an integrated circuit such as those fabricated with gallium arsenide or silicon. The integrated circuit usually has a large number of layers of metal conductors separated by one or more insulating materials(s). The composition for film formation (particularly polymer) of the present invention can be used as an insulator between discrete metal conductors in the same layer and/or between conductors of an interconnect structure. The composition for film formation of the present invention can also be used in combination with other materials such as SiO₂ or Si₃N₄, in a composite interconnect structure. For example, the oligomer and polymer of the present invention can be used in the production method of an integrated circuit device, taught in U.S. Pat. Nos. 5,550,405 and 5,591,677 and Hayashi et al., 1996 Symposium on VLSI Technology Digest of Technical Papers, pg. 88-89. The composition for film formation (oligomer or polymer) of the present invention can be used in place of BCB or other resins.

The composition for film formation (oligomer or polymer) of the present invention can be used as a dielectric material in the method for fabricating an integrated circuit article comprising an active substrate containing transistors and an electrical interconnect structure containing patterned metal lines which are at least partially separated by the layer of the composition of the present invention.

The composition for film formation (particularly polymer) of the present invention is also effective for the planarization of a material such as silicon wafer used in a semiconductor to realize the production of smaller (higher density) circuitry. In order to achieve desired planarity, the coating solution of the composition for film formation (oligomer or polymer) of the present invention is coated on a substrate from a solution, for example, by spin coating or spray coating to level the roughness on the substrate surface. This method is described in publications such as Bowden et al., Jenekhe, S A., Polymer Processing to Thin Films for Microelectronic Applications in Polymers for High Technology, American chemical Society, pp. 261-269 (1987).

In the fabrication of a microelectronics device, a relatively thin defectless film having a thickness of 0.01 to 20 micron, preferably from 0.1 to 2 micron, is usually attached on a substrate such as silicon, silicon-containing material, silicon dioxide, alumina, copper, silicon nitride, aluminum nitride, aluminum, quarts and gallium arsenide. The coating film is usually produced from a solution of, for example, an oligomer having a molecular weight of 3,000 Mn or less and 5,200 Mw or less in various organic solvents such as xylene, mesitylene, N-methylpyrrolidinone (NMP), γ-butyrolactone and n-butyl acetate. The dissolved oligomer or polymer is usually cast on a substrate by spin or spray coating. The thickness of the coating film can be controlled by changing the solid content or molecular weight, namely, viscosity, of the solution or by changing the spin speed.

The composition for film formation (oligomer or polymer) of the present invention can be coated by dip coating, spray coating or extrusion coating, preferably by spin coating. In all cases, the environment in the periphery of substrate and coating film before curing must be controlled to appropriate temperature and humidity. In particular, NMP absorbs water from the water vapor in the ambient air. When dissolved in NMP, the obtained solution must be protected from moist air and the film must be cast in a low humidity environment. In the case of using NMP as the solvent, the environment is preferably controlled to a relative humidity of less than 30% and a temperature of 27° C. or more. After the coating, the coating film may be cured by using one or more hot plate(s), an oven or a combination thereof.

Before coating the composition for film formation of the present invention, an adhesion accelerator such as those based on silane may be coated on the substrate or may be added directly to the coating solution.

The composition for film formation (oligomer or polymer) of the present invention can be used for a “damascene” metal inlay or subtractive metal patterning process for the fabrication of an integrated circuit interconnect structure. The fabrication process of damascene lines and vias are known in the art. See, for example, U.S. Pat. Nos. 5,262,354 and 5,093,279.

The patterning of material may be performed by a reactive ion etching method using oxygen, argon, helium, carbon dioxide, fluorine-containing compound or a mixture of such a gas with other gas, and using a photoresist “softmask” such as epoxy novolak, or a photoresist combined with an inorganic “hardmask” such as SiO₂, Si₃N₄ or metal.

The composition for film formation (oligomer or polymer) of the present invention can be used together with Al, Al alloy, Cu, Cu alloy, gold, silver, W or other common metal conductive material (for conductive lines and plugs) deposited by physical vapor deposition, chemical vapor deposition, evaporation, electrodeposition or other deposition methods. In addition to the basic metal conductor, another metal layer such as tantalum, titanium, tungsten, chromium, cobalt, or alloy or nitride thereof may be used to fill holes, enhance adhesion, impart a barrier, or elevate metal reflectivity.

Depending on the fabrication process, the dielectric material of the present invention or the metal may be removed or planarized by using a chemical-mechanical polishing method. On an active or passive substrate such as silicon, silicate glass, silicon carbide, aluminum, aluminum nitride or FR-4, a multichip module may be constructed by using the polymer of the present invention as a dielectric material.

Also, on an active or passive substrate such as silicon, silicate glass, silicon carbide, aluminum, aluminum nitride or FR-4, a flat panel display may be constructed by using the polymer of the present invention as a dielectric material.

The composition for film formation (oligomer or polymer) of the present invention may be used as a protective coating film on an integrated circuit chip for the protection against alpha particles. The semiconductor device is susceptible to soft errors when an alpha particle emitted from radioactive trace contaminants in the packaging collides against the active surface. The integrated circuit chip is usually mounted on a substrate and fixed by an appropriate adhesive. The coating film of the composition for film formation (particularly polymer) of the present invention provides an alpha particle protection layer to the active surface of the chip. If desired, further protection may be provided by an encapsulant made of, for example, epoxy or silicone.

The composition for film formation (particularly polymer) of the present invention may also be used as a substrate (dielectric material) in a circuit board or a printed wiring board. In this case, a pattern for various conductive circuits may be provided on the surface of the formed circuit board. This circuit board may contain, in addition to the polymer of the present invention, various reinforcing agents such as woven non-conducting fiber (for example, glass fiber). Such a circuit board may be single-sided, double-sided or multilayer.

The composition for film formation (particularly polymer) of the present invention is also effective in a reinforced composite material where a resin matrix polymer is reinforced by one or more reinforcing material(s) such as reinforcing fiber or mat. Examples of the reinforcing material include glass fiber, particularly glass fiber mat (woven or non-woven fabric), graphite, particularly graphite mat (woven or non-woven fabric), Kevlar (trademark), Nomex (trademark) and glass ball. This composite material can be produced from a preform or a dipping mat in monomer or oligomer or by resin transfer molding (where a mat is placed in the mold and a monomer or prepolymer is added and heated to polymerize).

The layer formed from the composition for film formation (particularly polymer) of the present invention is patterned by wet etching, plasma etching, reactive ion etching (RIE), dry etching or photo-laser ablation, such as those described in Polymers for Electronic Applications, Lai, CRC Press, pp. 42-47 (1989). The patterning is performed by a multi-level method where a pattern is lithographically formed in a resist layer coated on the polymeric dielectric layer and then etched into the bottom layer. A particularly effective method comprises masking the portions of oligomer or polymer not to be removed, removing the unmasked portions of oligomer or polymer, and curing the remaining oligomer or polymer, for example, under heating.

The composition for film formation (particularly oligomer) of the present invention can also be used for the production of a shaped article, a film, a fiber or a foam. For the production of such a product, a method well known in the art for casting an oligomer or polymer from a solution can be usually used.

In the production of a shaped article by using the composition for film formation (oligomer or polymer) of the present invention, additives such as filler, pigment, carbon black, conductive metal particle, abrasive and lubricating polymer may be used. The method of mixing such additives is not critical and the additives are preferably added to a oligomer or polymer solution before producing the shaped article. A liquid composition containing the oligomer or polymer alone or containing also a filler can be coated on a number of different substrates by a usual method (e.g., doctoring, rolling, dipping, brushing, spraying, spin coating, extrusion coating, meniscus coating). When the oligomer or polymer is produced in the solid form, the additives are added to a melt before processing it into a shaped article.

The composition for film formation (oligomer or polymer) of the present invention can be coated on various substrates by a number of methods such as solution deposition, liquid-phase epitaxy, screen printing, melt-spinning, dip coating, spinning, brushing (for example, as a varnish), spray coating, powder coating, plasma deposition, dispersion spraying, solution casting, slurry spraying, dry powder spraying, fluidized bed method, welding, explosion method (including Wire Explosion Spraying Method and explosion bonding), press bonding with heat, plasma polymerization, dispersion in a dispersion medium with subsequent removal of dispersion medium, pressure bonding, heat bonding with pressure, gaseous environment vulcanization, extruding molten polymer, hot gas welding, baking, coating and sintering. A mono- or multi-layer film can also be deposited on a substrate at an air-water or other interface by using a Langmuir-Blodgett method.

In the case of coating the composition for film formation (oligomer or polymer) of the present invention from a solution, most advantageous polymerization conditions and other processing parameters vary depending on many factors, particularly, the specific oligomer or polymer deposited, the coating conditions, the quality and thickness of coating film, and the end use. By taking account of these factors, the solvent is selected. Examples of the solvent which can be used are as described above.

The substrate coated with the composition for film formation (oligomer or polymer) of the present invention may be any material as long as it has sufficient integrity to be coated. Examples of the substrate include wood, metal, ceramics, glass, other polymers, paper, paper board, woven fabric, non-woven mat, synthetic fiber, Kevlar (trademark), carbon fiber, gallium arsenide, silicon, and other inorganic substrates and oxides thereof. The substrate used is selected based on the desired use. Examples thereof include glass fiber (woven, non-woven or strand), ceramics, metals (e.g., aluminum, magnesium, titanium, copper, chromium, gold, silver, tungsten, stainless steel, Hastalloy (trademark), carbon steel), other metal alloys and oxides thereof, and thermosetting or thermoplastic polymers (e.g., epoxy resin, polyimide, perfluorocyclobutane polymer, benzocyclobutane polymer, polystyrene, polyamide, polycarbonate, polyarylene ether, polyester). The substrate may also be the polymer of the present invention in the cured form.

The substrate may have any shape and the shape is determined according to the end use. For example, the substrate may have a shape of disk, plate, wire, tube, board, ball, rod, pipe, cylinder, brick, fiber, woven or non-woven fabric, yarn (including commingled yarn), ordered polymer, or woven or non-woven mat. In each case, the substrate may be hollow or solid. In the case of a hollow substrate, the polymer layer may be provided on either the inner side or outer side of the substrate or on both sides. The substrate may comprise a porous layer such as graphite mat or fabric, glass mat or fabric, scrim or particulate material.

The composition for film formation (oligomer or polymer) of the present invention adheres directly to many materials such as compatible polymer, polymer having a common solvent, metal, particularly textured metal, silicon or silicon dioxide, particularly etched silicon or silicon oxide, glass, silicon nitride, aluminum nitride, alumina, gallium arsenide, quartz and ceramic. However, in order to obtain high adhesion, a material for enhancing the adhesion may be introduced.

Examples of the adhesion accelerating material include silanes, preferably organosilanes such as trimethoxyvinylsilane, triethoxyvinylsilane, hexamethyl-disilazane [(CH₃)₃—Si—NH—Si (CH₃)₃], aminosilane coupling agents such as γ-aminopropyltriethoxysilane, and chelates such as aluminum monoethylacetoacetatediisopropylate [(isoC₃H₇O)₂Al(OCOC₂H₅CHCOCH₃)]. In some cases, the adhesion accelerator is coated as a 0.01 to 5 weight % solution, excess solution is removed, and then polyphenylene is applied. In other cases, for example, a chelate of aluminum monoethylacetoacetatediisopropylate may be incorporated onto a substrate by spreading a toluene solution of the chelate on the substrate and then baking the coated substrate at 350° C. for 30 minutes in oxygen to form a very thin (for example, 5 nanometer) adhesion accelerating layer of aluminum oxide on the surface. Other means for depositing aluminum oxide are likewise suitably used. Also, the adhesion accelerator in an amount of, for example, from 0.05 to 5 weight % based on the weight of the monomer can be mixed with the monomer before polymerization so as to eliminate the need for forming another layer.

As for the application of the composition for film formation (particularly oligomer) of the present invention, in a more preferred embodiment of the present invention, a silane-based adhesion accelerator containing 3-aminopropyl silane dissolved in methanol, which is available as VM-652 from DuPont or as AP8000 from The Dow Chemical Company, is first coated on a wafer surface, slowly spread over the entire surface, allowed to stand for 2 seconds, and finally dried by rotation at 3,000 rpm for 10 seconds. Thereafter, 4 mL of an oligomer solution is fed on the surface of a wafer with a diameter of 200 mm by using a high-precision pump/filtration system, Millipore Gen-2, while rotating the wafer at 750 rpm. The wafer rotation is elevated to 2,000 rpm immediately after the feeding and held at that rotation speed for 20 seconds. A continuous stream of mesitylene is coated on the back surface of the wafer for 5 seconds during the feeding of the oligomer solution. After the spin coating, the film is dried on a hot plate at 70° C. for 20 seconds. After the dry-baking step, the 2 to 5 mm-edge bead of the coating film is removed by applying a continuous stream of mesitylene from the back surface or directly from the above near the edge while rotating the wafer at 2,000 rpm. After the removal of edge bead, the oligomer is further polymerized on a hot plate at 325° C. for 90 seconds in a nitrogen blanket. Thereafter, the film is crosslinked on a hot plate at 450° C. for 2 minutes in nitrogen, or in a nitrogen-purged oven at 450° C. for 6 minutes.

The composition for film formation (oligomer or polymer) of the present invention may be applied together with other additives so as to obtain predetermined results. Examples of such additives include metal-containing compounds such as magnetic particle (for example, barium ferrite, iron oxide (if desired, a mixture with cobalt), or other metal-containing particles for use in magnetic mediums, optical mediums or other recording mediums), and conductive particles such as metal or carbon for use as conductive sealant, conductive adhesive, conductive coating, electromagnetic interference (EMI)/radio frequency interference (RFI) shielding coating, static dissipation or electrical contact. In the case of using such additives, the oligomer or polymer of the present invention acts as a binder.

The composition for film formation (oligomer or polymer) of the present invention may also be used as protection against the environment (that is, protection against at least one substance in the environment including conditions of production, storage and use), such as coating to impart surface passivation to metals, semiconductors, capacitors, inductors, conductors, solar cells, glass, glass fibers, quartz and quartz fibers.

### EXAMPLES

The following Examples are set forth to illustrate the present invention and should not be construed to limit the scope of the present invention. In the Examples, unless otherwise indicated, all parts and percentages are on the weight basis.

### Example 1

A mixture containing 2.6 g of Compound (P-1) shown below, 0.6 g of Compound (D-3) shown below, 0.5 g of Compound (D-1) shown below and 15 g of N-methyl-pyrrolidinone was purged with nitrogen and then stirred in an oil bath at 200° C. for 24 hours. The resulting solution was filtered through a 0.1-micron tetrafluoroethylene-made filter and spin-coated on a silicon wafer to form a coating film having a thickness of 1 micron. The obtained coating film was heated on a hot plate at 150° C. for 60 seconds in a nitrogen stream and further heated on a hot plate at 300° C. for 90 seconds. This silicon wafer was further placed in a nitrogen-purged oven and heated at 400° C. for 1 hour to prepare a cured coating film.

### Example 2

A cured coated film was prepared in the same manner as in Example 1 except for replacing the compounds by 2.6 g of (P-1), 0.6 g of (D-2) shown below and 0.5 g of (D-1).

### Example 3

A mixture containing 2.6 g of Compound (P-2) shown below, 0.6 g of Compound (D-3), 0.5 g of Compound (D-10) shown below and 15 g of 1,2,4-trichlorobenzene was purged with nitrogen and then stirred in an oil bath at 220° C. for 50 hours. By using this solution, a cured coating film was prepared according to the method of Example 1.

### Example 4

A cured coated film was prepared in the same manner as in Example 1 except for replacing the compounds by 3.7 g of (P-13) shown below, 0.6 g of (D-2) and 0.5 g of (D-1).

### Example 5

A cured coated film was prepared in the same manner as in Example 1 except for replacing the compounds by 2.6 g of (P-1) and 1.0 g of (D-1).

### Comparative Example 1

A mixture containing 2.6 g of Compound (P-1), 1.3 g of Compound (D-3) and 15 g of N-methylpyrrolidinone was purged with nitrogen and then stirred in an oil bath at 200° C. for 8 hours. By using this solution, a cured coating film was prepared according to the method of Example 1.

### Comparative Example 2

A cured coated film was prepared in the same manner as in Example 1 except for replacing the compounds by 3.7 g of (P-13) and 1.3 g of (D-2).

Evaluation 1

The coating films prepared in Examples 1 to 5 and Comparative Examples 1 and 2 were subjected to the following evaluations. ps (1) Uniformity of Film Thickness

The thickness of coating film was measured at 50 points by using an optical thickness meter and the average value was determined. Then, 3σ of the obtained film thickness was calculated and the results are shown in Table 1.

(2) Heat Resistance

The coating film prepared was held at 430 to 450° C. for 3 hours in a nitrogen atmosphere and the film thickness decreasing rate per hour was examined.

(3) Gap Filling Ability

A patterned wafer was coated with the composition for film formation and after curing, the obtained 6 inch-diameter wafer with a 1 μm-thick cured film layer was split by a normal method. The cross section of the coated wafer was observed through a scanning electron microscope to examine whether the gap size and groove depth on the wafer were completely filled. The width (μm) of a minimum gap filled completely without defects was measured.

(4) Relative Dielectric Constant

The relative dielectric constant of the obtained film was calculated from the capacity value at 1 MHz by using Mercury probe produced by Four Dimensions, Inc. and HP4285ALCR meter produced by Yokokawa Hewlett Packard Ltd.

The results of these evaluations are shown in Table 1.

(5) Mechanical Strength (Young's modulus)

The measured results of Yong's modulus of the obtained films at 25° C. by using Nano Indentor SA2 produced by MTS System Corporation were shown in Table 1.

Structures of Compounds Used in Examples and Comparative Examples:

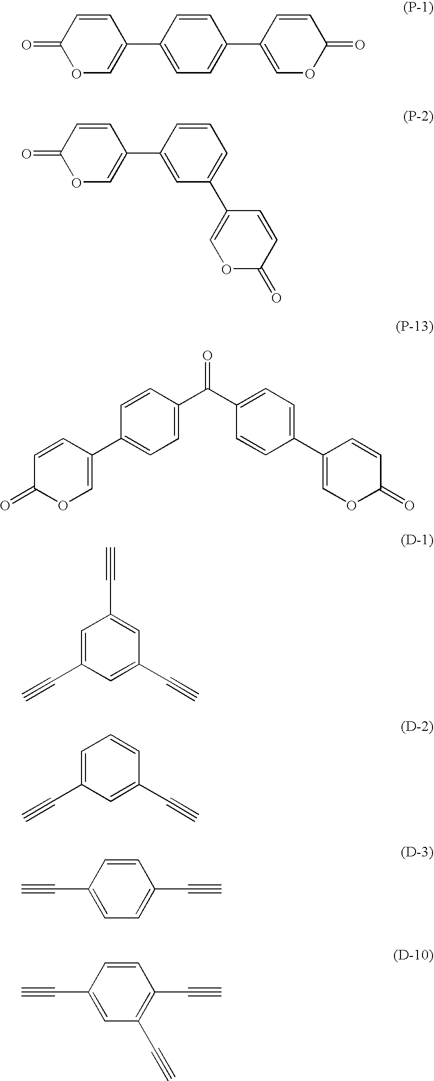

TABLE 1

| | | | Width of | | |
|---|---|---|---|---|---|
| | | | Minimum | | |
| | | | Groove | | |
| | Uniformity | Heat | Filled | | |
| | of Film | Resis- | Com- | Relative | Young's |
| | Thickness | tance | pletely | Dielectric | Modulus |
| | (%) | (%/h) | (μm) | Constant | (GPa) |
| Example 1 | <3 | <1.0 | <0.4 | 2.56 | 7.8 |
| Example 2 | <3 | <1.0 | <0.4 | 2.58 | 7.9 |
| Example 3 | <3 | <1.0 | <0.4 | 2.57 | 8.0 |
| Example 4 | <3 | <1.0 | <0.4 | 2.57 | 7.9 |
| Example 5 | <3 | <1.0 | <0.4 | 2.57 | 7.8 |
| Comparative | 5 | 4.0 | 2.0 | 2.68 | 3.2 |
| Example 1 | | | | | |
| Comparative | 5 | 4.0 | 2.0 | 2.68 | 3.2 |
| Example 2 | | | | | |

It is seen from Table 1 that the composition for film formation of the present invention is excellent in the planarity, heat resistance, relative dielectric constant, mechanical strength and groove filling as compared with

### Comparative Examples.

The coating film formed by using the composition for film formation of the present invention is excellent in the planarity and heat resistance and capable of filling gaps without leaving a void and has good abilities of relative dielectric constant and mechanical strength, therefore, can be used, for example, as an interlayer insulating film in electronic devices and the like.

The entire disclosure of each and every foreign patent application from which the benefit of foreign priority has been claimed in the present application is incorporated herein by reference, as if fully set forth.

1. A composition for a film formation, the composition obtained by a Diels-Alder reaction of at least one compound (A) having two or more 2-pyrone groups with at least one compound (B) having two or more dienophile functional groups,
wherein the composition satisfies at least one of a condition (a) and a condition (b):
condition (a): said at least one compound (A) includes a compound having three or more 2-pyrone groups; and
condition (b): said at least one compound (B) includes a compound having three or more dienophile functional groups.

2. The composition according to claim 1,
wherein said at least one compound (A) is represented by formula (I):
[P-(L¹)ₘ [symbol] ₙQ (I)
wherein n represents an integer of 2 or more;
each of P's represents a 2-pyrone group;
each of L¹'s represents a divalent linking group;
Q represents an aliphatic hydrocarbon group, an aromatic hydrocarbon group or a heterocyclic group; and
each of m's represents 0 or 1, and each of P's, L¹'s and m's are the same or different.

3. The composition according to claim 1,
wherein said at least one compound (B) is represented by formula (II): 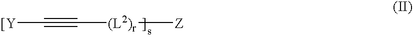
wherein s represents an integer of 2 or more;
each of Y's represents a hydrogen atom, an alkyl group or an aryl group;
each of L²'s represents a divalent linking group;
Z represents an aliphatic hydrocarbon group, an aromatic hydrocarbon group or a heterocyclic group; and
each of r's represents 0 or 1, and each of Y's, L²'s and r's are the same or different.

4. The composition according to claim 1, comprising at least one of an oligomer, an uncured polymer and a cured polymer, each obtained by the Diels-Alder reaction.

5. The composition according to claim 1, which is capable of forming a film having a Young's modulus of 5 GPa or more.

6. The composition according to claim 1, which is capable of forming a film having a relative dielectric constant of 2.60 or less.

7. A film obtained by a process, the process comprising using a composition for a film formation according to claim 1.

8. The film according to claim 7, the using comprising:
applying the composition to a substrate to produce an applied composition; and
heating the applied composition at a temperature of from 100° C. to 475° C., so as to form the film.

9. The film according to claim 8,
wherein the heating the applied composition is performed for 1 minute to 10 hours.

10. The film according to claim 7, which has an uniformity of a film thickness of less than 3%.

11. The film according to claim 7, which has a Young's modulus of 5 GPa or more.

12. The film according to claim 7, which has a relative dielectric constant of 2.60 or less.

13. A coating solution for a film formation, comprising a composition for a film formation according to claim 1.

14. An electronic device having an insulating film obtained by using a coating solution for a film formation according to claim 13.
